(19) United States
(12) Patent Application Publication
(10) Pub. No.: US 2026/0249445 A1
(43) Pub. Date: Aug. 27, 2026

(54) MODULAR RECONFIGURABLE ROBOTIC EXOSKELETON SYSTEM OPERABLE IN AUTONOMOUS HUMANOID AND WEARABLE MODES

(71) Applicants: Abdulaziz Suliman Alshen, Sterling, VA (US); Abdullah Suliman Alshen, Jeddah (SA); Renad Suliman Alshen, Jeddah (SA)

(72) Inventors: Abdulaziz Suliman Alshen, Sterling, VA (US); Abdullah Suliman Alshen, Jeddah (SA); Renad Suliman Alshen, Jeddah (SA)

(21) Appl. No.: 19/551,072

(22) Filed: Feb. 26, 2026

Related U.S. Application Data
(60) Provisional application No. 63/763,465, filed on Feb. 26, 2025.

(51) Int. Cl. B25J 9/08; B25J 9/00; B62D 57/032

(52) U.S. Cl. CPC B25J 9/08; B25J 9/0006; B62D 57/032

(57) ABSTRACT

A modular reconfigurable robotic exoskeleton system is disclosed that is selectively operable in an autonomous humanoid robot mode and a wearable exoskeleton mode. The system has structural frame constructed from perforated tubular members having perforations at regular intervals that accept standard mechanical fasteners, enabling repositionable mounting of joint assemblies, actuators, sensors, and accessories without welding. Actuators may be repositioned along with the perforations to selectively configure various lever mechanical advantage arrangements. In autonomous mode, an AI-enabled control system selectively commands the actuators. In exoskeleton mode, the frame is wearable via an adjustable harness system, and the control system processes signals sensors to actuate joints in coordination with user motion, amplifying physical strength. The system is modularly reconfigurable into full humanoid, upper-body-only, multi-arm, crane-equipped, vehicle-mounted, and partial-body assistive configurations. The perforated mounting architecture functions as a universal interface for various components, enabling broad adaptability across disparate fields.

### CROSS REFERENCE TO RELATED APPLICATION

This application claims the benefit of priority of U.S. provisional application number 63/763,465, filed Feb. 26, 2025, the contents of which are herein incorporated by reference.

### BACKGROUND OF THE SUBJECT DISCLOSURE

The subject disclosure relates generally to robotic and wearable assistive systems, and more particularly to a modular, reconfigurable robotic exoskeleton platform that is operable in a fully autonomous humanoid robot mode and in a wearable exoskeleton mode for augmenting human physical strength and endurance. The subject disclosure further relates to perforated structural frameworks, interchangeable actuation systems, and universal mounting architectures enabling broad customization for industrial, medical, military, rehabilitative, and entertainment applications.

Many labor-intensive industries rely on human workers to perform repetitive, hazardous, or physically demanding tasks, leading to increased risk of injury, fatigue, reduced operational efficiency, and high costs. These challenges affect blue-collar sectors such as manufacturing, construction, and logistics, as well as white-collar roles involving inspection, maintenance, and field service—particularly in environments demanding precision, strength, and endurance over extended periods.

Traditional wearable exoskeleton systems offer limited mobility and strength augmentation. They are often bulky, energy-intensive, expensive, or restricted to passive support, reducing their practicality in real-world industrial or personal settings. Passive exoskeletons generally rely on spring or elastic mechanisms that provide only modest assistance and cannot adapt dynamically to changing task demands. Active powered exoskeletons exist but are typically engineered for a single purpose, are not reconfigurable, and cannot function independently as autonomous robots.

Meanwhile, conventional humanoid robots are typically expensive, underpowered, non-versatile, and lack the adaptability to perform across multiple roles. Critically, existing humanoid robots cannot convert into wearable systems or physically interface with human users in an assistive capacity. Robotic and exoskeleton technologies have heretofore been developed as discrete, incompatible product categories, requiring separate procurement, maintenance, and operation.

A need exists in the art for a unified, modular robotic platform that (i) functions as a fully autonomous humanoid robot capable of performing complex labor, (ii) rapidly reconfigures into a wearable powered exoskeleton for human strength augmentation, (iii) provides a universal perforated structural framework accommodating a wide variety of actuator types, limb configurations, sensor packages, and third-party accessories, and (iv) achieves these objectives at materially lower cost than existing systems through the use of widely available industrial components.

### SUMMARY OF THE SUBJECT DISCLOSURE

The subject disclosure is directed to a modular reconfigurable robotic exoskeleton system comprising a structural frame constructed from perforated tubing, a plurality of joint assemblies mounted at articulation points of the frame, at least one actuation system coupled to the frame, a sensor and control system governing operation, and a harness system enabling the frame to be worn by a human user. The system is operable in at least two primary modes: an autonomous humanoid robot mode and a wearable exoskeleton mode.

In one aspect, the subject disclosure provides a modular robotic exoskeleton system includes a structural frame having a plurality of perforated tubular members having perforations at regular intervals; a plurality of joint assemblies disposed at articulation points defined by the frame, each joint assembly enabling rotational movement between adjacent frame members; at least one actuator mechanically coupled between frame members to produce controlled relative motion; a control system operably connected to the at least one actuator; and a user attachment system comprising adjustable straps or harnesses at load-bearing areas of the frame, wherein the system is selectively configurable between an autonomous operational mode and a wearable exoskeleton mode.

In another aspect, the subject disclosure provides a method of operating a modular reconfigurable robotic exoskeleton system, the method including the following: selecting between an autonomous humanoid robot mode and a wearable exoskeleton mode; in the autonomous mode, commanding a plurality of actuators via a control system to perform assigned tasks without direct human physical assistance; and in the wearable exoskeleton mode, attaching the frame to a human user via an adjustable harness and operating the actuators in synchronization with the user's movement to amplify the user's physical strength and reduce muscular fatigue.

In yet another aspect, the subject disclosure provides a modular structural framework for a robotic or exoskeletal system providing the following: perforated tubular members of at least one cross-sectional profile selected from the group consisting of square, rectangular, circular, and polygonal profiles, wherein the perforations are dimensioned and spaced to receive standard fasteners enabling repositionable mounting of actuators, joints, linkages, sensors, and accessories can be welded, bolted, fastened, harnessed, etc. or any other permanent or non-permanent fixation connection.

Additional aspects, features, and advantages of the subject disclosure will be apparent from the detailed description set forth below and the accompanying drawings.

In one aspect of the subject disclosure, a modular reconfigurable robotic exoskeleton system includes the following: a structural frame comprising a plurality of perforated tubular members or, can be flat frame, or any ridged frame, can be tightened, welded, pinned, clamped, etc., each having a plurality of perforations at regular intervals dimensioned to receive mechanical fasteners also, can perforated or non-perforated clamped or tightened; a plurality of joint assemblies disposable along the structural frame to define articulation points enabling rotational movement between adjacent perforated tubular members; at least one actuator mechanically coupled between perforated tubular members at one or more selectable positions along the perforations to produce controlled relative motion of adjacent frame members; a control system operably connected to the at least one actuator and configured to command actuation of the joint assemblies; and a user attachment system comprising a plurality of adjustable harnesses disposed at load-bearing locations of the structural frame; wherein the system is selectively configurable between an autonomous humanoid robot mode in which the control system actuates the joint assemblies without a human wearer, and a wearable exoskeleton mode in which the structural frame is worn by a human user via the user attachment system and the control system provides force amplification to augment the user's physical strength.

These and other features, aspects and advantages of the subject disclosure will become better understood with reference to the following drawings, description and claims.

### BRIEF DESCRIPTION OF THE DRAWINGS

FIG. 1 is a perspective view of an exemplary embodiment of the subject disclosure in assembled humanoid configuration, showing principal structural and actuator components.

FIG. 2 is a front view of an exemplary embodiment of the subject disclosure showing bilateral symmetry of the limb assemblies and torso structure.

FIG. 3 is an exploded perspective view of an exemplary embodiment of the subject disclosure showing all major component assemblies and their spatial relationships.

FIG. 4 is a side elevation view of an exemplary embodiment of the subject disclosure.

FIG. 5 is a detailed perspective view of a joint assembly according to an exemplary embodiment of the subject disclosure.

FIG. 6 is an exploded detailed view of an exemplary embodiment of the joint assembly showing constituent components.

FIG. 7 is a detailed perspective view of an end-effector hand assembly according to an exemplary first embodiment.

FIG. 8 is a side view of the end-effector hand assembly of FIG. 7.

FIG. 9 is a perspective view of an alternative end-effector hand assembly according to a second embodiment; and

FIG. 10 is a side elevation view of the alternative end-effector hand assembly of FIG. 9.

FIG. 11 is an elevation perspective view of an exemplary embodiment of the subject disclosure.

### LIST OF REFERENCE NUMERALS

The following reference numerals are used consistently throughout the drawings:
10—Back/Shoulder Structure
12—Connection Points (Frame)
14—Back Adjuster
16—Back/Hip Assembly
18—Back Base
20—Connection Points (Secondary)
22—End Connectors
24—Angle Adjusters
26—Shoulder Assemblies
28—90-Degree Turn Fittings
30—90-Degree Connectors
32—Bicycle Head
34—Upper Arm Members
36—Upper Joints
38—Lower Joints
40—Alternative Lower Joints
42—Links/Linkage Members
44—Upper Leg Members
46—Lower Leg Members
48—Lower Arm Members
50—Bicycle Fork
52—Clevis Mount Rod Eye
54—Foot Assemblies
56—Platforms/Foot Platforms
58—Pins/Fasteners
60—Hand Assemblies (Primary)
62—Finger Members
64—Alternative Hand Assembly
66—Hydraulic Rams/Linear Actuators

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

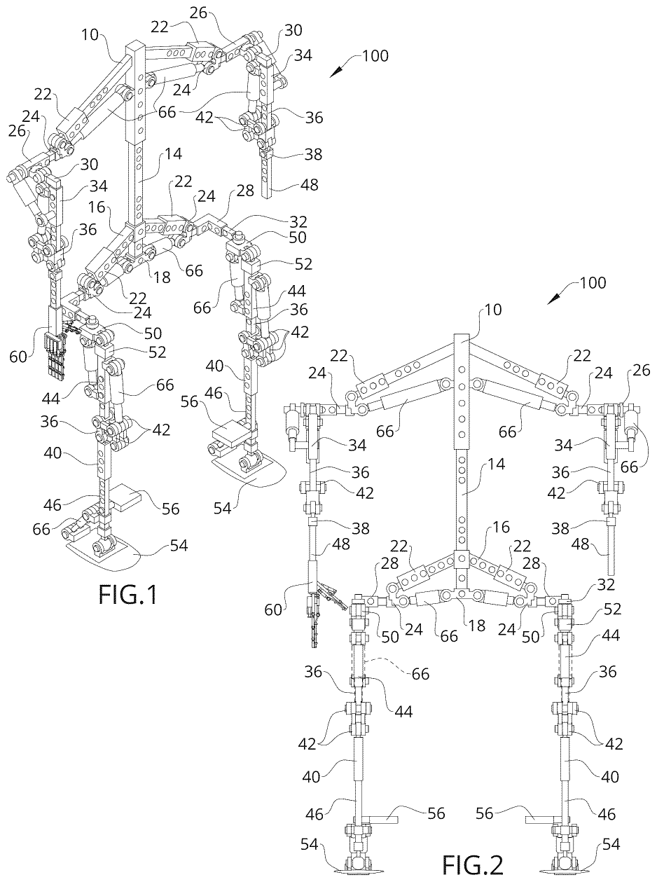

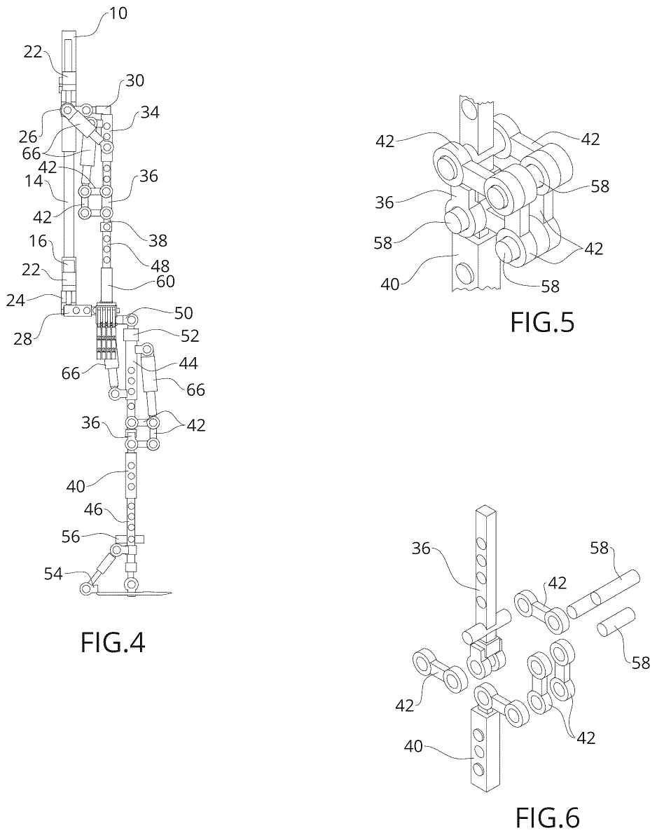

Referring generally to FIGS. 1-4, the modular reconfigurable robotic exoskeleton system 100 of the subject disclosure comprises a structural frame assembly, a plurality of joint assemblies, at least one actuation system, a sensor and control system, and a user attachment system. In its default configuration (FIGS. 1 and 2), system 100 assumes a humanoid bipedal form with articulated upper and lower limbs organized about a central torso structure. In certain embodiments, the skeletal framework may include one or more longitudinal support members extending along the torso or back of the wearer. The support members may be arranged as a single central spine, dual parallel spines on each side of the torso, or any combination thereof, with open space or structural gaps between them. The configuration is not limited to a human-like anatomy and may be optimized for load bearing, modularity, or integration with additional components.

In addition to the previously described perforated-hole length adjustment mechanism, an alternative embodiment may include a telescopic linear actuator assembly. The telescopic assembly may comprise multiple nested tubular members configured to extend and retract relative to one another.

The extension mechanism may be driven manually or by an internal actuation system including, but not limited to, an electric motor with a lead screw, ball screw, rack-and-pinion system, cable-driven system, hydraulic cylinder, or pneumatic cylinder. This embodiment allows continuous or programmable length adjustment, as opposed to discrete positioning provided by perforated-hole locking systems.

The exoskeleton may include one or more longitudinal rails, tracks, or keyed channels configured to receive sliding modular components. It also may include snap-fit, bayonet, or quarter-turn engagement mechanisms configured for rapid installation and removal. The exoskeleton may include one or more universal modular attachment interfaces configured to mechanically, magnetically, electrically, or structurally couple auxiliary components to the frame.

The attachment interface may include any removable or permanent coupling mechanism capable of securing an auxiliary module to the structural framework. The attachment interface may include aligned apertures configured to receive removable fastening members including pins, bolts, screws, rivets, or other mechanical fasteners. The attachment may include clamping assemblies configured to compress around structural members of the exoskeleton, including split collars, cam-lock clamps, toggle clamps, band clamps, or compression rings.

The length adjustment mechanism may include, but is not limited to, telescopic assemblies, sliding rails, scissor or pantograph mechanisms, rack-and-pinion systems, lead screws, ball screws, linear actuators, hydraulic or pneumatic cylinders, spring-loaded members, manually adjustable rods or pins, perforated-hole systems, clamps, lever-actuated mechanisms, cam-locks, or any combination thereof.

The mechanism may be configured to provide continuous or discrete adjustment of the length, angle, or position of a structural member, and may be driven manually, electrically, hydraulically, pneumatically, magnetically, or by any other mechanical or electromechanical means suitable for the intended application.

The length adjustment mechanism may be incorporated into any portion of the skeletal framework, including limbs, spine, torso, or appendages, and may serve functions including, but not limited to, modular assembly, strength adjustment, user-specific sizing, rehabilitation resistance, or task-specific configuration.

System 100 is selectively operable in at least two primary modes: (a) an autonomous humanoid robot mode and (b) a wearable exoskeleton mode, as described in further detail below. The highly modular architecture further permits reconfiguration into a variety of non-humanoid forms including upper-body-only configurations mounted on wheeled bases, multi-arm configurations, quadruped configurations, or specialized industrial platform configurations.

The structural frame assembly forms the skeletal chassis of system 100 and may be constructed primarily from a plurality of perforated tubular members. As shown in FIGS. 1-4, the frame includes back/shoulder structure 10, back adjuster 14, back/hip assembly 16, back base 18, upper arm members 34, lower arm members 48, upper leg members 44, lower leg members 46, and foot assemblies 54, among other structural elements identified by the following reference numerals listed above. Bicycle head 32, bicycle fork 50 (or tube that goes through the bicycle head 32 holes to move the entire frame element), and clevis mount rod eye 52 allow the frame elements to rotate around their axis sometimes called “medial rotation”. The clevis mount rod eye 52 connects to the frame element, via pins, bolts, weld, etc., and the rod eye goes to attach to a clevis.

The tubular members may be fabricated from any material providing adequate structural integrity for load-bearing applications, including but not limited to aluminum alloy, structural steel, stainless steel, carbon fiber composite, reinforced polymer, titanium alloy, or combinations thereof. The structural members of the skeletal framework are not limited to tubular shapes and may include rods, beams, plates, sheets, shells, or other structural forms suitable for the intended function. The members may be fabricated from any material providing adequate structural integrity for the job, depending on the expected load and application. For example, a home-use or light-duty robot may employ materials such as plastics, polymers, aluminum, or composites, while heavier-duty or industrial embodiments may utilize structural steel, stainless steel, carbon fiber composites, titanium alloys, or combinations thereof. The choice of material and cross-sectional geometry may vary across different portions of the framework to optimize weight, strength, modularity, or other performance characteristics. The tubular members may have cross-sectional profiles of any suitable geometry, including but not limited to square, rectangular, circular, oval, hexagonal, or other polygonal profiles. In preferred embodiments, the tubular members are hollow, enabling internal routing of electrical cables, hydraulic lines, pneumatic tubing, or rope and cable assemblies in a manner analogous to a spinal cord running within a vertebral column. Furthermore, the perforated tubular members enable a telescopic relationship with adjacent components; for instance, the upper leg 44 is sized and adapted to receive a distal portion of the upper joint 36. Additionally, the perforations enable the telescopically associated components to be selectively locked at a desired spatial and dimensional arrangement relative to each other. Alternatively, in higher-load applications, solid bar stock may be substituted.

A defining feature of the structural frame is the perforated hole system, wherein each perforated tubular member is provided with a plurality of perforations spaced at regular intervals—for example, approximately every 5 -15 cm along the member's length—dimensioned to receive standard mechanical fasteners such as bolts, pins, or clevis pins (e.g., M8, M10, or M12 metric fasteners, or equivalent imperial fasteners). The perforations may be threaded or unthreaded. This perforation system functions analogously to a universal pegboard or modular rail system (conceptually similar to LEGO Technic, Meccano, VEX Robotics, or Picatinny/NATO tactical rail systems), enabling any component—actuators, joints, sensors, accessories, tools, protective covers, or user-supplied custom modules—to be attached, repositioned, or removed at any location along the member without welding.

Structural components may be joined using any suitable fastening method, including bolted connections, quick-release pin connections, clamping mechanisms (e.g., C-clamps, toggle clamps, squeeze clamps), snap-fit connectors, or welded joints for permanent high-load installations. This flexibility supports field repair, user customization, and role-specific reconfiguration.

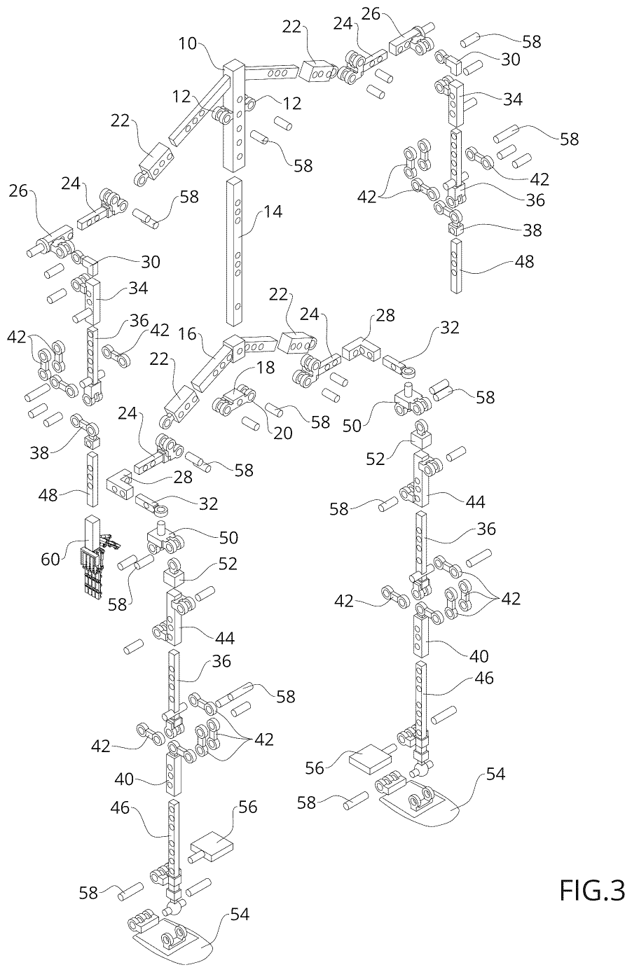

Connection points 12, 20, end connectors 22, angle adjusters 24, 90-degree turn fittings 28, and 90-degree connectors 30, shown in detail in FIG. 3, enable the frame to be assembled in a variety of angular and spatial configurations. In one illustrated instance, shoulder assemblies 26 may be mounted to the upper torso and provide the primary attachment interface for the upper limb assemblies. Pins and fasteners 58 are used throughout to secure connections.

### Joint Assemblies

Referring to FIGS. 5 and 6, joint assemblies are disposed at major articulation points of the frame, including but not limited to the shoulder, elbow, wrist, hip, knee, and ankle positions. Each joint assembly enables controlled rotational movement between adjacent frame members. The joint assemblies include upper joints 36, lower joints 38, and alternative lower joints 40, as well as associated links and linkage 42.

The joint assemblies may incorporate any suitable rotary bearing technology, including but not limited to ball bearings, roller bearings, bushings, plain bearings, spherical bearings (rod-end bearings), clevis pin joints, hinge joints, or universal joints. The circular cutouts or housing recesses within the joint assemblies are dimensioned to accept drive shafts, bolts, or square-drive adapters (e.g., standard ½-inch square drive) to enable installation of gear reductions, torque multipliers, or rotary actuators. Joints may be designed to be mechanically or electronically lockable to hold positions under load, providing a safety hold function during autonomous operation or exoskeleton use.

Linkage 42 provides structural connections between joints and frame segments. Additional parallel linkage members may be incorporated alongside primary limbs to form parallel linkage systems that maintain the orientation of attached loads or tools throughout the range of motion—similar in principle to scissor-lift or four-bar linkage mechanisms used in industrial lifting equipment—thereby minimizing tilt and improving load stability.

### Actuation System

The actuation system generates the forces and displacements necessary to move the limbs of system 100. Hydraulic rams/linear actuators 66 are shown in the illustrated embodiment as the primary actuators. However, the subject disclosure is not limited to any particular actuator technology. The actuation system may employ any one or more of the following actuator types, alone or in combination: (a) hydraulic cylinders; (b) pneumatic cylinders; (c) electric linear actuators; (d) gear-reduction electric motors; (e) servo motors; (f) stepper motors; (g) cable-driven mechanisms with pulleys, chain hoists, or block-and-tackle systems; (h) rack-and-pinion drives; (i) ball screw or lead screw drives; (j) planetary gearbox drives; (k) shape-memory alloy actuators; (l) magnetorheological or electrorheological fluid actuators; or (m) internal combustion or gasoline-powered actuators in heavy-duty configurations.

A key feature of the subject disclosure is the adjustable mechanical advantage system enabled by the perforated frame. Actuators are mounted between frame members using the perforated hole system, and by relocating the actuator attachment point or pivot (fulcrum) along the perforated member, the user can dynamically adjust between lever class configurations:

First-Class Lever Configuration: The actuator is positioned on the opposite side of the pivot from the load—for example, behind the shoulder joint—such that the fulcrum lies between the effort (actuator) and the load (arm/payload). This configuration, analogous to excavator boom operation, maximizes force output and is preferred for heavy lifting applications.

Second-Class Lever Configuration: The load is positioned between the fulcrum and the effort, maximizing mechanical advantage for intermediate force requirements.

Third-Class Lever Configuration: The effort is applied between the fulcrum and the load; for example, in front of the shoulder joint, analogous to human bicep operation, maximizing speed and range of motion at reduced force.

This lever-class adjustability allows a single system to be tuned for torque-intensive tasks (e.g., heavy lifting) or speed-intensive tasks (e.g., rapid manipulation) by simple repositioning of actuator mounting points, without hardware replacement.

In preferred embodiments for heavy-duty operation, the system uses electric linear actuators or hydraulic cylinders similar in type to those found in electric jacks, construction equipment, or industrial automation systems. Such actuators, combined with appropriate gear reductions, can achieve lifting capacities in the range of approximately 100 to 1,000 pounds-force or greater, depending on configuration. The use of widely available off-the-shelf industrial actuator components enables a materially lower system cost compared to purpose-built robotic drives.

Passive assist components, including springs, elastic bands, rubber dampers, or counterbalance systems, may be integrated at any joint position to passively offset gravitational loads, reduce energy consumption during sustained operation, or provide fail-safe support in the event of power loss. These passive components complement but do not replace the active actuation system.

### End-Effector and Hand Assemblies

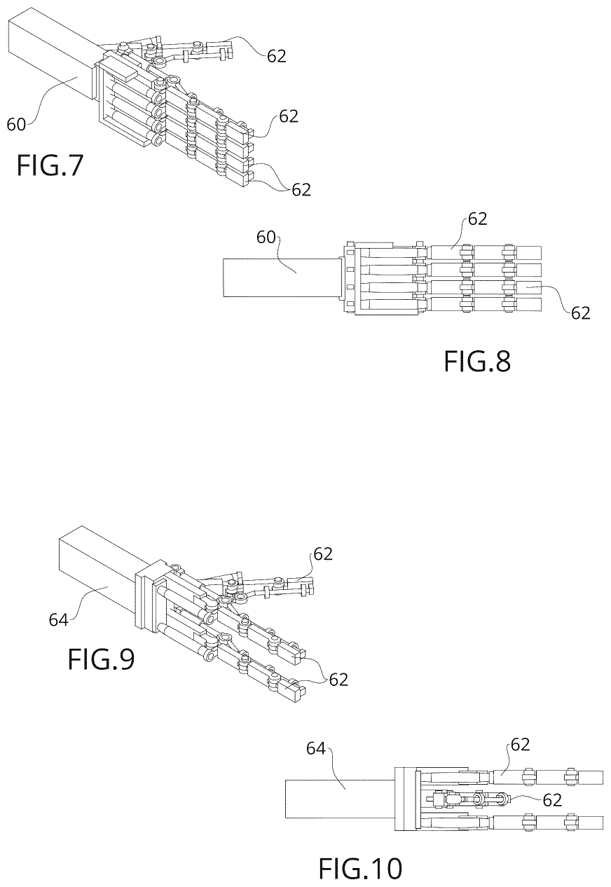

Referring to FIGS. 7-10, the distal ends of the upper limb assemblies are provided with end-effector assemblies, including hand assemblies 60 and alternative hand assembly 64. In the primary embodiment (FIGS. 7-8), hand assembly 60 includes a plurality of articulated finger members 62 arranged to replicate human-hand grasping functionality. Each finger member 62 may be independently actuated or operated in cooperative groups to achieve a variety of grasp types including power grasp, precision pinch, and lateral pinch.

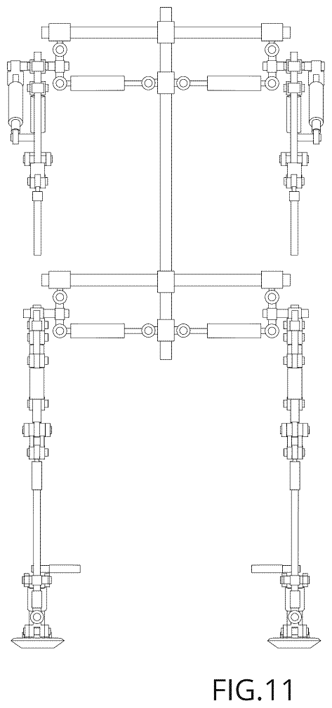

In the alternative embodiment (FIGS. 9-10), hand assembly 64 provides a differently configured end-effector suitable for specialized tasks. The modular connection interface between the end-effector assembly and the lower arm member 48 is standardized through the perforated hole system, enabling rapid tool-change without mechanical tools where quick-release fasteners are employed. End-effectors are not limited to hand or finger configurations; any of the following may be substituted: parallel-jaw grippers, magnetic grippers, suction cup grippers, welding torches, spray nozzles, drilling heads, sensor pods, camera mounts, or other task-specific tools.

### Sensor and Control System

The sensor and control system governs all aspects of system operation in both autonomous and exoskeleton modes. The control system may include one or more of the following processing platforms: microcontrollers (e.g., Arduino-class devices), single-board computers (e.g., Raspberry Pi-class devices), embedded industrial computers, edge AI inference processors, or external cloud-connected computing systems. The control system communicates with the actuation system through motor driver circuits, hydraulic valve controllers, or pneumatic solenoid valves, as appropriate to the actuator type employed.

Sensing modalities that may be integrated into the system include, without limitation: (a) inertial measurement units (IMUs) including accelerometers and gyroscopes for orientation and motion tracking; (b) joint position encoders (optical, magnetic, or resistive) for limb position feedback; (c) force/torque sensors at joints and end-effectors for load monitoring and compliant control; (d) electromyography (EMG) sensors for detecting user muscle activation intent in exoskeleton mode; (e) pressure pad sensors at body contact points for user interaction detection; (f) laser displacement sensors or LiDAR units for environmental distance measurement; (g) stereo cameras or depth sensors for three-dimensional environmental mapping and object recognition; (h) tactile or capacitive sensors on end-effectors for object contact detection; and (i) strain gauges on structural members for structural health monitoring.

In autonomous mode, the control system executes pre-programmed task routines, responds to sensor-based environmental feedback, or receives real-time commands via wired or wireless communication interfaces including Wi-Fi, Bluetooth, or dedicated radio frequency links. AI-based motion planning and task-execution software may be deployed on the onboard computing platform or accessed via a connected network to enable adaptive task performance in unstructured environments.

In exoskeleton mode, the control system processes sensor signals, (particularly from IMUs, joint encoders, force sensors, and optional EMG sensors) to detect the user's intended movements and actuate the corresponding joints in real time to provide responsive force amplification. A safety and feedback layer continuously monitors actuator loads, joint angles, and acceleration to detect and prevent overextension, excessive loads, or unsafe conditions, triggering actuator deactivation or passive hold states as required. User interfaces may include wearable LCD displays, mobile smartphone applications, voice command interfaces, or desktop software platforms.

Power for the system may be provided by a rechargeable battery system, preferably lithium-ion or lithium-polymer battery packs, which may be located at any convenient position on the frame including the foot assemblies 54, back base 18, torso, or distributed across multiple locations for weight balance optimization. Battery packs may be fixed or hot-swappable for extended operational duration. Alternative or supplemental power sources may include solar panels, tethered AC/DC power supplies, fuel cells, or capacitor-based energy storage.

Electrical wiring, hydraulic lines, pneumatic tubing, and rope or cable assemblies are routed either internally through the hollow tubular frame members or externally along the outside of the frame and are secured using standard cable management means. Internal routing protects lines from environmental exposure and mechanical damage while maintaining a clean external profile.

### User Attachment System (Exoskeleton Mode)

To configure the system 100 in wearable exoskeleton mode, a user attachment system is employed to secure the structural frame to the human operator's body. The user attachment system comprises a plurality of adjustable harnesses, straps, padding elements, and/or rigid saddle mounts positioned at key anatomical load-bearing locations including, but not limited to the waist/hip; the thighs; the lower legs/shins; the forearms; the upper arms/biceps; the shoulders; and optionally the chest and chin. Harness elements may employ Velcro closures, buckle clips, lacing systems, magnetic closures, or custom-fit rigid cuffs, and are adjustable to accommodate a wide range of user body sizes and proportions.

Shock-absorbing components—including spring elements, rubber dampers, or viscoelastic foam pads—may be interposed between the frame and the user's body at contact interfaces to improve comfort, distribute pressure, and attenuate impact forces during dynamic activities. Similarly, shock-absorbing foot platforms 56 may incorporate spring or damper elements beneath foot assemblies 54 to reduce ground-impact forces during locomotion.

### Operational Modes

Autonomous Humanoid Robot Mode: In this mode, system 100 operates as a fully self-contained robotic platform without a human wearer. The user attachment system is disengaged or absent. The control system executes motion commands based on pre-programmed routines, real-time sensor feedback from the environment, or remote operator commands received via wireless interface. The system can perform a broad range of physical tasks including lifting, carrying, placing, manipulating objects, operating machinery, and interacting with digital interfaces. AI-based software may be employed to enable adaptive task planning, obstacle avoidance, and learning from prior task execution. The modular limb configuration in autonomous mode is not limited to humanoid form; the user may configure additional arm assemblies, attach specialized end-effectors, or reconfigure the lower limbs to non-bipedal configurations as operational needs require.

Wearable Exoskeleton Mode: In this mode, a human user dons the system 100 by securing the user attachment system at the prescribed anatomical locations. Upon activation, the control system detects user movement intent via the sensor array and actuates the joints in coordination with the user's natural motion. The actuation system provides force amplification enabling the user to lift, carry, and manipulate loads substantially exceeding normal human capability—in preferred embodiments, in the range of approximately 100 to 1,000 pounds-force or more depending on actuator selection and configuration. The exoskeleton mode further supports a passive assist sub-mode wherein active actuation is reduced or disabled and spring/elastic passive elements provide ergonomic strain relief during low-demand tasks or in power-conservation scenarios. Safety monitoring is continuous throughout exoskeleton operation.

Mode Transition: The system is designed to support rapid field transition between autonomous and exoskeleton modes through software-selectable mode settings and the quick-adjustment of the user attachment system. No structural disassembly is required for mode transition in the preferred embodiment.

### Modular Configurations and Specialized Applications

Full Humanoid Configuration (FIGS. 1-4): The system includes bilateral upper and lower limb assemblies organized about a central torso, providing full-body autonomous operation or full-body exoskeleton support. This configuration is preferred for general industrial labor, construction, logistics, and military applications.

Upper-Body-Only Configuration: The lower limb assemblies 44, 46, 54, 56 are removed and the torso/upper-body assembly is mounted on a wheeled base, tracked platform, or vehicle. This configuration reduces cost, weight, and power consumption while retaining full arm and hand functionality, and is preferred for indoor service robotics, domestic applications, seated assembly-line tasks, or cost-sensitive deployments.

Multi-Arm Configuration: Additional arm assemblies beyond the standard bilateral pair are mounted to the torso frame at various heights and angles using the perforated hole system. Each additional arm may be independently actuated and equipped with its own end-effector. Multi-arm configurations enable parallel multi-task execution, enhance lifting capacity through coordinated arm loading, or replication of multi-limb industrial robot architectures.

Crane/Hoist Configuration: An L-shaped crane or winch attachment is mounted to the upper rear portion of the back frame 10 at the position analogous to the C1 vertebra in human anatomy extending upward and outward above the head. A pulley, rope, or chain hoist system supported by this L-frame enables vertical lifting of heavy loads directly above the system's center of gravity, functioning analogously to a compact shop crane or engine hoist integrated into the robotic frame.

Alternative Mobility Configurations: Lower limb assemblies may be replaced with or augmented by wheeled bases, tracked drive systems, roller-equipped foot assemblies (analogous to roller shoes), or custom terrain-specific mobility platforms. This enables deployment on smooth indoor floors (wheels), rough outdoor terrain (tracks), or specialized surfaces.

Vehicle-Mounted Configuration: The torso assembly may be detached from leg assemblies and mounted on vehicles, industrial platforms, carts, or amusement ride frameworks, enabling mobile task execution or entertainment applications such as robotic animatronics or theme park ride systems.

Partial-Body Assistive/Prosthetic Configuration: The modular system may be offered in partial configurations supplying support to specific body regions: (a) upper-body-only for shoulder, arm, and back augmentation in warehouse, rehabilitation, or partial mobility support applications; (b) lower-body-only for walking assistance, posture correction, or leg strength augmentation in elderly care, mobility impairment support, or physical therapy; or (c) single-limb configurations functioning as powered prosthetic limb replacements for individuals who have lost one or more limbs.

Also, the exoskeleton can be used as active resistive training and/or programmable load functionality. In one embodiment, where the exoskeletal robotic framework is configured to operate in an active resistance mode for strength training, rehabilitation, neuromuscular conditioning, and performance enhancement applications. In certain embodiments, the actuators (electric, hydraulic, pneumatic, magnetic, or other force-generating systems) may be programmable to provide controlled resistance against the natural movement of the wearer. The resistance level may be adjustable manually, algorithmically, or dynamically via sensor feedback. This allows the device to function as (including but not limited to): a wearable resistance training system; a rehabilitation assistive/resistive device; a programmable strength-conditioning apparatus; a neuromuscular re-education tool; and a full-body wearable gym system.

Actuators may generate force opposing joint motion (e.g., elbow flexion, knee extension), like resistance bands or weight machines, thereby enabling simulated environmental resistance. System 100 can simulate (Including but not limited to): moving through mud; swimming underwater; walking through sand; high-gravity conditions; and viscous fluid resistance. This may create full-body distributed resistance simulating muscle building, increasing resistance during lengthening muscle contractions to promote hypertrophy and rehabilitation benefits.

Likewise, a reactive resistance mode may allow for resistance to dynamically changes based on (Including but not limited to): movement speed; heart rate; EMG feedback; fatigue detection; and rehabilitation progress algorithms.

Additional broad use cases are enabled, including but not limited to: post-injury rehabilitation, sports performance enhancement, military or tactical conditioning, astronaut microgravity muscle maintenance, physical therapy clinics, home-based training, geriatric strength maintenance, metabolic conditioning, and occupational strength conditioning.

Protective shell integration is also possible, which may include external protective housing elements, armor plates, or cosmetic shells may be fastened to the structural frame through the perforated hole system using bolts, clamps, or quick-release fasteners, providing environmental protection for internal components, impact protection for the human user, or task-specific functional outer surfaces.

### Exemplary Method of Manufacture

A method of manufacturing system 100 according to a preferred embodiment comprises the following steps, which may be performed in any suitable order:
(1) Fabricating or procuring perforated tubular frame members of the selected material (e.g., aluminum alloy extrusion) and cross-sectional profile (e.g., square or circular), with perforations spaced at regular intervals and dimensioned to accept the selected fastener standard.
(2) Assembling joint assemblies at major articulation points using the selected bearing technology (e.g., ball bearings and clevis pins) and securing to frame members via the perforated hole system.
(3) Fitting the system with user-contact padding, harness attachment points, and adjustable straps at the prescribed anatomical load-bearing locations.
(4) Installing the selected sensor suite—including at minimum one IMU and one joint position sensor per actuated joint—and routing sensor cabling internally through hollow frame members or externally with cable management.
(5) Mounting the selected actuators between frame members at the initial desired lever-class position using the perforated hole fastening system.
(6) Installing the battery system at the selected location(s) on the frame and connecting to the power distribution system.
(7) Installing the computing and control platform, configuring firmware and control software, and establishing communication interfaces (wired and/or wireless).
(8) Attaching end-effectors to the distal upper limb assemblies using the standardized perforated connection interface.
(9) Performing functional verification testing in both autonomous and exoskeleton operational modes.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A modular reconfigurable robotic exoskeleton system comprising:
a structural frame comprising a plurality of perforated tubular members, each having a plurality of perforations at regular intervals dimensioned to receive mechanical fasteners;
a plurality of joint assemblies disposable along the structural frame to define articulation points enabling rotational movement between adjacent perforated tubular members;
at least one actuator mechanically coupled between perforated tubular members at one or more selectable positions along the perforations to produce controlled relative motion of adjacent frame members;
a control system operably connected to at the least one actuator and configured to command actuation of the joint assemblies; and
a user attachment system comprising a plurality of adjustable harnesses disposed at load-bearing locations of the structural frame;
wherein the system is selectively configurable between an autonomous humanoid robot mode in which the control system actuates the joint assemblies without a human wearer, and a wearable exoskeleton mode in which the structural frame is worn by a human user via the user attachment system and the control system provides force amplification to augment the user's physical strength.
